(19) United States
(12) Patent Application Publication
(10) Pub. No.: US 2007/0210704 A1
(43) Pub. Date: Sep. 13, 2007

(54) Electroluminescent device using nanorods

(76) Inventors: Shang-Hyeun Park, Boryeong-si (KR); Jeong-Na Heo, Yongin-si (KR); Jeong-Hee Lee, Seongnam-si (KR); Tae-Won Jeong, Seoul (KR)

Correspondence Address: Robert E. Bushnell, Suite 300, 1522 K Street, N.W., Washington, DC, 20005, US

(21) Appl. No.: 11/524,847

(22) Filed: Sep. 22, 2006

(30) Foreign Application Priority Data
Mar. 9, 2006 (KR) 10-2006-0022324

(51) Int. Cl. H01J 1/62; H01J 63/04

(52) U.S. Cl. 313/506

(57) ABSTRACT

An electroluminescent device may be constructed with a first electrode and a second electrode which are spaced apart from each other and face each other, an inorganic light emitting layer formed between the first and second electrodes, a dielectric layer formed on an inner surface of the second electrode, and a field emission layer which is formed on at least one of an upper or lower surface of the inorganic light emitting layer and which is made from nanorods having a large aspect ratio.

### CLAIM OF PRIORITY

This application makes reference to, incorporates the same herein, and claims all benefits accruing under 35 U.S.C. § 119 from an application for ELECTROLUMINESCENT DEVICE USING NANORODS earlier filed in the Korean Intellectual Property Office on 9 Mar. 2006 and there duly assigned Serial No. 10-2006-0022324.

### BACKGROUND OF THE INVENTION

1. Field of the Invention

The present invention relates to an electroluminescent device, and more particularly, to an inorganic electroluminescent device that can operate using a decreased driving voltage and has an increased brightness and luminous efficiency.

2. Description of the Related Art

In a contemporary inorganic electroluminescent device, a first substrate, a first electrode, an inorganic light emitting layer, a dielectric layer, a second electrode and a second substrate are sequentially stacked. The inorganic electroluminescent device is driven by an alternating current (AC) voltage and electroluminescence is realized in the inorganic light emitting layer.

In the above inorganic electroluminescent device, when a voltage is applied between the first electrode and the second electrode, an electric field is generated within the inorganic light emitting layer. Electrons accelerated by the electric field collide with a phosphor material in the light emitting layer to excite the phosphor material. Therefore, visible light is emitted from the inorganic light emitting layer.

In order to increase the brightness of the emitted light and reduce the driving voltage of the inorganic electroluminescent device, however, we have found that it is necessary to further accelerate the electrons into a higher energy level by forming an intensified electric field in the inorganic light emitting layer.

### SUMMARY OF THE INVENTION

It is therefore an object of the present invention to provide an improved electroluminescent device.

It is another object of the present invention to provide an electroluminescent device that has a reduced driving voltage and an increased brightness and luminous efficiency.

It is still another object to provide an electroluminescent device able to accommodate an intensified electric field in its inorganic light emitting layer.

According to an aspect of the present invention, an electroluminescent device may be constructed with a first electrode and a second electrode spaced apart from each other and facing each other, an inorganic light emitting layer formed between the first and second electrodes, a dielectric layer formed in an inner surface of the second electrode, and a field emission layer which is formed on at least one of an upper or lower surface of the inorganic light emitting layer and made from nanorods.

The nanorods may comprise nanowires. The nanowires may be made from ZnO, TiO₂, or SiC. The nanorods may comprise vertically aligned carbon nanotubes (CNTs).

The inorganic light emitting layer may be made from at least one of an electroluminescent (EL) phosphor material and a cathode luminescence (CL) phosphor material.

The first electrode may be made from a transparent conductive material. The second electrode may be made from a transparent conductive material or an electrically conducting metal.

The electroluminescent device may be further constructed with a dielectric layer on an inner surface of the first electrode.

An alternate current voltage may be applied between the first and second electrodes.

According to another aspect of the present invention, an electroluminescent device may be constructed with a first electrode and a second electrode which are spaced apart from each other and face each other, a field emission light emitting layer which is disposed between the first and second electrodes and made from a mixture of a field emission material made from nanorods and an inorganic light emitting material; and a dielectric layer formed on an inner surface of the second electrode.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a contemporary inorganic electroluminescent device;

FIG. 2 is a cross-sectional view of an electroluminescent device constructed as an embodiment of the principles of the present invention;

FIGS. 3A and 3B are scanning electron microscope (SEM) images, made at different resolution scales of 6.00 μm and 600 nm respectively, showing carbon nanotubes (CNTs) formed by a chemical vapor deposition (CVD) method;

FIGS. 4A and 4B are SEM images, made at different resolution scales of 10.0 μm and 3.00 μm respectively, showing CNTs formed using a CNT paste;

FIG. 5 is a cross-sectional view of an electroluminescent device constructed as another embodiment of the principles of the present invention;

FIG. 6 is an SEM image made at a resolution scale of 10.0 μm showing a mixture of 2 wt % ZnO nanowires with a phosphor material; and

FIG. 7 is a two-coordinates graph of driving voltage as a function of the brightness of light obtained from electroluminescent devices including a contemporary electroluminescent device and electroluminescent devices constructed as embodiments of the principles of the present invention.

### DETAILED DESCRIPTION OF THE INVENTION

The present invention will now be described more fully with reference to the accompanying drawings in which exemplary embodiments of the invention are shown. In the drawings, the thicknesses of layers and regions are exaggerated for clarity.

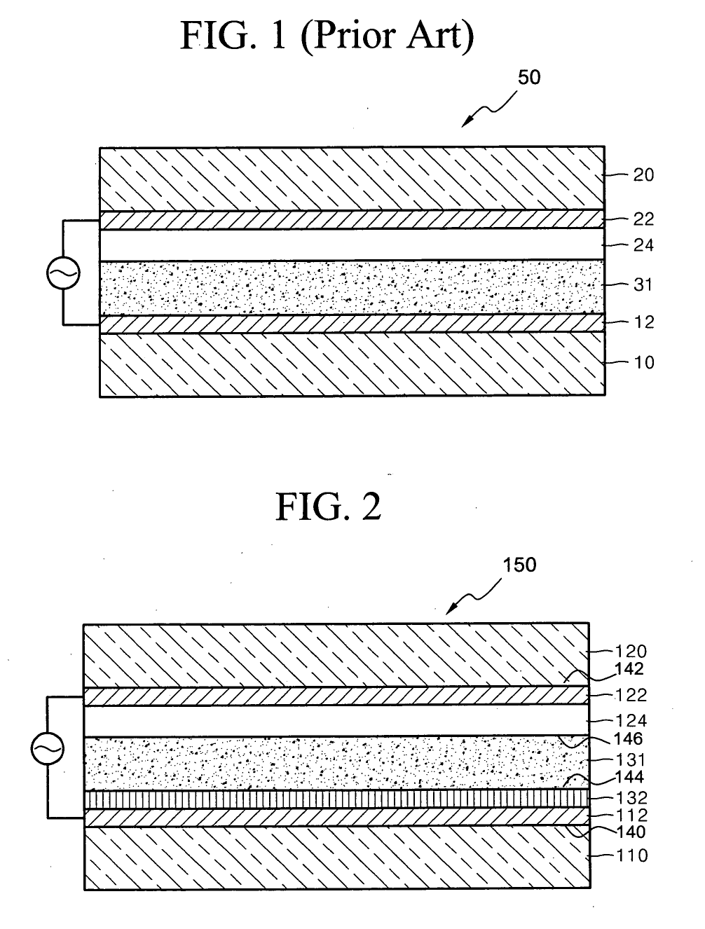

FIG. 1 is a cross-sectional view of a contemporary inorganic electroluminescent device. Referring to FIG. 1, a first electrode 12 made from transparent indium tin oxide (ITO) is formed on a first substrate 10, and an inorganic light emitting layer 31 where electroluminescence is realized, is formed on first electrode 12. A dielectric layer 24 and a second electrode 22 are sequentially stacked on the inorganic light emitting layer 31, and a second substrate 20 is formed on an upper surface of second electrode 22. The above inorganic electroluminescent device is driven by a voltage 8 of alternating current (AC) form.

In the above inorganic electroluminescent device, when a predetermined voltage is applied between first electrode 12 and second electrode 22, an electric field is formed in inorganic light emitting layer 31. Electrons accelerated by the electric field collide with a phosphor material in the emitting layer 31 to excite the phosphor material. Therefore, visible light is emitted from inorganic light emitting layer 31. This configuration however, inexplicably lacks adequate brightness in the resulting images emitted.

FIG. 2 is a cross-sectional view of an electroluminescent device constructed as an embodiment of the principles of the present invention. Referring to FIG. 2, electroluminescent device 150 is constructed with first and second electrodes 112 and 122 that face each other and are spaced apart from each other, an inorganic light emitting layer 131 formed between the first and second electrodes 112 and 122, a dielectric layer 124 formed between inorganic light emitting layer 131 and a lower surface of the second electrode 122, and a field emission layer 132 formed between first electrode 112 and a lower surface of the inorganic light emitting layer 131.

A first substrate 110 acting as a lower substrate can be formed on a lower surface 140 of first electrode 112. First substrate 110 can be made from transparent glass or plastic material. A second substrate 120 acting as an upper substrate can be further formed on an upper surface 142 of the second electrode 122. Second substrate 120 can be made from transparent glass or plastic material, which is similar in characteristics and composition to what first substrate 110 is made from.

First electrode 112 can be made from a transparent and electrically conductive material, for example, ITO. Second electrode 122 can also be made from a transparent and electrically conductive material or an electrically conducting metal such as Ag.

Inorganic light emitting layer 131 is a layer where electroluminescence is realized. Electrons accelerated by an electric field generated in inorganic light emitting layer 131 collide with a phosphor material. As a result, the phosphor material is excited to high energy levels, and then, when the phosphor material is stabilized and drops to lower energy levels, visible light is emitted. Inorganic light emitting layer 131 can be made from an electroluminescent (EL) phosphor material commonly used for inorganic electroluminescent devices. In the present embodiment, inorganic light emitting layer 131 can also be made from a cathode luminescent (CL) phosphor material generally used for display devices such as cathode ray tubes (CRTs) and field emission displays (FEDs). Dielectric layer 124 is disposed between second electrode 122 and inorganic light emitting layer 131, and can be made from, for example, SiO₂.

Field emission layer 132 is formed between inorganic light emitting layer 131 and first electrode 112. Field emission layer 132 is disposed to contact a lower surface 144 of inorganic light emitting layer 131. In the present embodiment, field emission layer 132 may be made from nanorods, in order to enable increases of the intensity of the electric field generated within inorganic 2 light emitting layer 131, by strongly concentrating the electric field generated by an external source. Accordingly, a large number of electrons can be accelerated into a higher energy level in inorganic 4 light emitting layer 131.

Field emission layer 132 can be formed using a screen printing method, a chemical vapor 6 deposition (CVD) or physical vapor deposition (PVD) method, an electro-deposition method, or a doctor blade method.

The nanorods can be nanowires. Nanowires have a lateral size of approximately tens of nanometers or less and an unconstrained longitudinal size. Therefore, nanowires have an aspect ratio which is substantially larger than 5. The nanowires can be made from, for example, ZnO, TiO₂ or SiC. The nanowires can be vertically aligned in field emission layer 132, i.e. aligned perpendicular to inorganic light emitting layer 131, to further increase the concentration of electric field formed in inorganic light emitting layer 131. In an alternative embodiment however, the nanowires may not be vertically aligned.

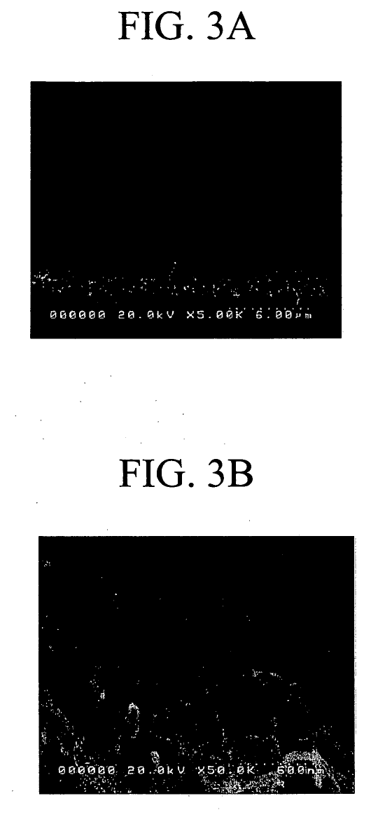

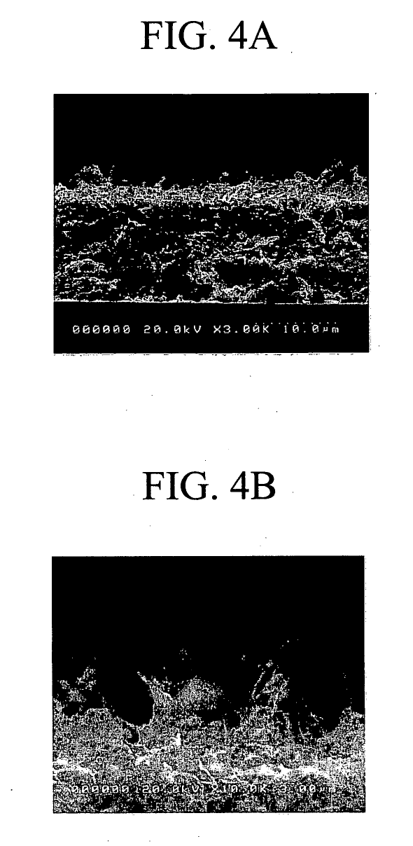

The nanorods can be vertically aligned carbon nanotubes (CNTs). The diameter of a nanotube is on the order of a few nanometers, while they can be up to several millimeters in length. Therefore, nanotube have an aspect ratio which is substantially larger than 5. FIGS. 3A through 4B are SEM images showing vertically aligned CNTs. More specifically, FIG. 3A is a SEM image made at a resolution scale of 6.00 μm of multi walled nanotubes (MWNTs) formed using a CVD method, and FIG. 3B is an enlarged view of the SEM image of FIG. 3A, made at a resolution scale of 600 nm. FIG. 4A is a SEM image made at a resolution scale of 10.0 μm of single walled nanotubes (SWNTs) formed using a CNT paste, and FIG. 4B is an enlarged view of the SEM image of FIG. 4A, made at a resolution scale of 3.00 μm.

In the electroluminescent device having the structure shown in FIG. 2, when a predetermined voltage is applied between first and second electrodes 112 and 122, the electric field generated between first and second electrodes 112 and 122 is strongly concentrated due to the presence of nanorods in field emission layer 132, thereby the intensity of the electric field formed within inorganic light emitting layer 131 is increased. An AC voltage may be applied between first and second electrodes 112 and 122. In general, the stronger the intensity of an electric field formed in inorganic light emitting layer 131, the larger the number of electrons that are accelerated to a higher energy level. As a result, brightness of the visible light emitted from inorganic light emitting layer 131 increases. Therefore, in the present embodiment, a strong electric field is realized in inorganic light emitting layer 131 by field emission layer 132 made from nanorods, and accordingly, high brightness visible light can be emitted from inorganic light emitting layer 131. The visible light is emitted out of the device through transparent first substrate 110 to provide a source of light for realizing images. The electroluminescent device constructed as the above embodiment of the principles of the present invention can increase brightness and luminous efficiency with a reduced driving voltage in comparison to a contemporary electroluminescent device.

In the above embodiment, field emission layer 132 made from nanorods is formed between first electrode 112 and inorganic light emitting layer 131. In another embodiment of the principles of the present invention, however, field emission layer 132 made from nanorods can be formed between second electrode 122 and inorganic light emitting layer 131. In this case, field emission layer 132 may be formed to contact an upper surface 146 of inorganic light emitting layer 131. Alternatively, in still another embodiment of the principles of the present invention, field emission layer 132 may be disposed both between first electrode 112 and inorganic light emitting layer 131 and between second electrode 122 and inorganic light emitting layer 131. In this case, first field emission layer 132 may be disposed to contact both the upper surface and the lower surface of inorganic light emitting layer 131. In the above embodiment, dielectric layer 124 is formed on an inner surface of second electrode 122 which is facing toward light emitting layer 131, and another dielectric layer (not shown) can be further formed on an inner surface of first electrode 112 which is facing toward light emitting layer 131.

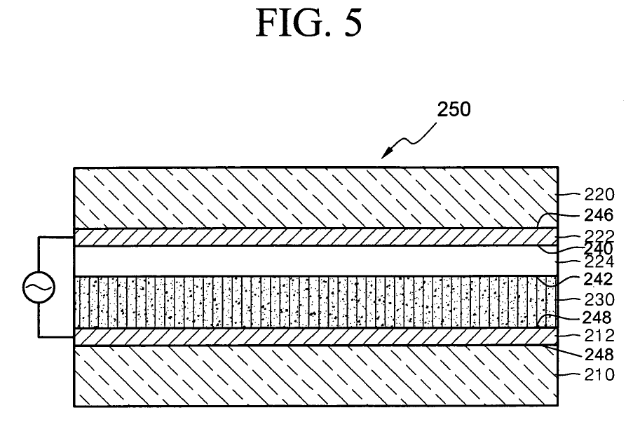

FIG. 5 is a cross-sectional view of an electroluminescent device 250 constructed as another embodiment of the principles of the present invention. Referring to FIG. 5, electroluminescent device 250 is constructed with first and second electrodes 212 and 222 which are spaced apart from each other and face each other, a field emission light emitting layer 230 formed between first and second electrodes 212 and 222, and a dielectric layer 224 formed between a lower surface 240 of second electrode 222 and an upper surface 242 of field emission light emitting layer 230.

A first substrate 210 acting as a lower substrate can be formed on a lower surface 244 of first electrode 212. First substrate 210 can be made from transparent glass or plastic material. A second substrate 220 acting as an upper substrate can be further formed on an upper surface 246 of second electrode 222. Second substrate 220 can be made from transparent glass or plastic material, which is similar in characteristics and composition to what first substrate 210 is made from.

First electrode 212 can be made from a transparent and electrically conductive material, for example, ITO. Second electrode 222 can also be made from a transparent and electrically conductive material or an electrically conducting metal such as Ag.

Field emission light emitting layer 230 is made from a mixture of an inorganic light emitting material and a field emission material. The inorganic light emitting material is a material in which electroluminescence is realized in response to an electric field generated in field emission light emitting layer 230, and which emits visible light when the energy level of the inorganic light emitting material drops to a lower energy level after the inorganic light emitting material is excited by impingement of electrons which have been accelerated by an electric field applied to field emission light emitting layer 230. The inorganic light emitting material can be made from an electroluminescent (EL) phosphor material commonly used for inorganic electroluminescent devices. In the present embodiment, the inorganic light emitting material can also be made from a CL phosphor material generally used for display devices such as CRTs and FEDs.

The field emission material may be made from nanorods. The field emission material made from nanorods increases the intensity of an electric field formed in the inorganic light emitting material by strongly focusing electric fields generated by an external source. Accordingly, a large number of electrons can be accelerated into high energy levels in the inorganic light emitting material.

The nanorods can be nanowires. The nanowires can be made from, for example, ZnO, TiO₂ and SiC. The nanowires can be vertically aligned in the field emission light emitting layer 230, i.e. perpendicular to first substrate 210 to further increase the focusing of the electric field formed in field emission light emitting layer 230. The present invention, however, is not limited to this arrangement. That it, the nanowires do not have to be vertically aligned. Also, the nanorods can be vertically aligned CNTs.

In the field emission light emitting layer 230 composed of a mixture of the phosphor material and the nanorods, the amount of the nanorods with respect to the phosphor material may be about 0.01 through 10 wt %. The wt % is defined as the ratio of the weight of the nanorods to the weight of the phosphor material in the specification. If the amount of the nanorods is greater than 10 wt %, it is difficult to make a paste due to significant increase of the total volume of the nanorods, and the brightness may be reduced in case that the nanorods are CNTs.

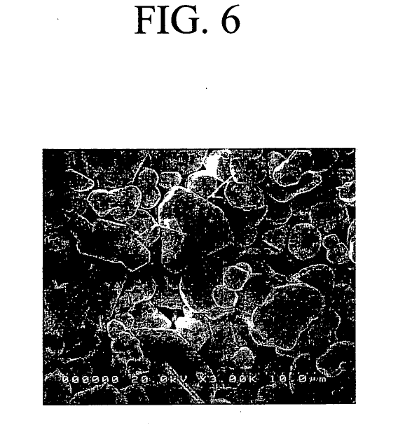

To form field emission light emitting layer 230, a field emission material made from nanorods and an inorganic light emitting material are mixed. Afterward, field emission light emitting layer 230 can be formed by coating the mixture on an upper surface 248 of first electrode 212 by using a printing method or a doctor blade method. FIG. 6 is an SEM image made at a resolution scale of 10.0 μm showing the surface texture of a mixture of 2 wt % ZnO nanowires with a phosphor material.

Dielectric layer 224 is formed between second electrode 222 and field emission light emitting layer 230, and can be made from, for example, SiO₂.

In the electroluminescent device having the structure as shown in FIG. 5, when a predetermined voltage is applied between first and second electrodes 212 and 222, the field emission material in field emission light emitting layer 230 strongly focuses electric fields generated between first and second electrodes 212 and 222. Accordingly, the intensity of the electric field formed within the inorganic light emitting material is increased, and thus, a large number of electrons are accelerated to high energy levels. Here, an AC voltage may be applied between first and second electrodes 212 and 222. As a result, very bright visible light can be emitted from the inorganic light emitting material in field emission light emitting layer 230. The visible light emitted out of the device through transparent first substrate 210 forms variable visual images for the human eye.

In the above embodiment, dielectric layer 224 is formed only on an inner surface 246 of second electrode 222. A dielectric layer (not shown), however, can also be further formed on an inner surface 248 of first electrode 212.

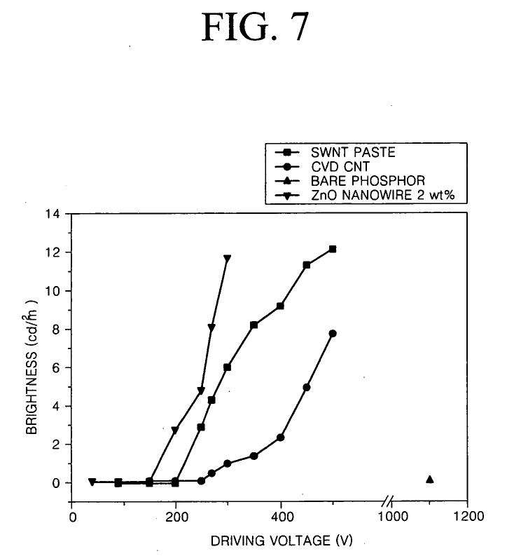

FIG. 7 is a two-coordinate graph illustrating driving voltage as a function of the brightness of light obtained from electroluminescent devices including a contemporary electroluminescent device and electroluminescent devices constructed as embodiments of the principles of the present invention. In the two-coordinate graph shown in FIG. 7, the single delta represents a measurement made of driving voltage as a function of the brightness of light obtained from a contemporary electroluminescent device as depicted in FIG. 1. The solid line with circular dots represents measurements made of driving voltage as a function of the brightness of light obtained from an electroluminescent device constructed as an embodiment of the principles of the present invention as depicted in FIG. 2, in which the field emission layer used was made from CNTs formed using a CVD method, and more specifically, from vertically arranged MWNTs. The solid line with squares represents measurements made of driving voltage as a function of the brightness of light obtained from an electroluminescent device constructed as another embodiment of the principles of the present invention as depicted in FIG. 2, in which the field emission layer used was made from CNTs formed using a CNT paste, and more specifically, from vertically arranged SWNTs. The solid line with dels represents measurements made of driving voltage as a function of the brightness of light obtained from an electroluminescent device constructed as still another embodiment of the principles of the present invention as depicted in FIG. 5, in which the field emission light emitting layer used was made from a mixture of a phosphor material and 2 wt % ZnO nanowires.

Referring to FIG. 7, both the electroluminescent device having field emission layer made from SWNT paste and the electroluminescent device having field emission layer made from CVD grown CNT, constructed as embodiments of the principles of the present invention as depicted in FIG. 2, show an increased brightness compared to the contemporary electroluminescent device. The electroluminescent device having a field emission light emitting layer made from a mixture of a phosphor material and 2 wt % ZnO nanowires, constructed as another embodiment of the principles of the present invention as depicted in FIG. 2, shows a further increased brightness compared to the electroluminescent device of the first two embodiments of the present invention. It is also obvious that the electroluminescent device having the field emission layer made from vertically arranged SWNTs has a higher brightness than the electroluminescent device having the field emission layer made from vertically arranged MWNTs.

As described above, an electroluminescent device constructed according to the principles of the present invention can have a greatly increased brightness of visible light emitted from an inorganic light emitting material by the expedient of increasing the intensity of the electric field formed within the inorganic light emitting material by using a field emission material made from nanorods. These electroluminescent device can also have an increased luminous efficiency and a reduced driving voltage because a desired brightness of visible light may be obtained by applying a relatively low voltage to the electroluminescent device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electroluminescent device comprising:
a first electrode and a second electrode spaced apart from each other and facing each other;
an inorganic light emitting layer formed between the first and second electrodes;
a dielectric layer formed on an inner surface of the second electrode; and
a field emission layer formed on at least one of an upper and lower surface of the inorganic light emitting layer and made from nanorods.

2. The electroluminescent device of claim 1, comprised of the nanorods comprising nanowires.

3. The electroluminescent device of claim 2, comprised of the nanowires being made from ZnO, TiO₂, or SiC.

4. The electroluminescent device of claim 2, comprised of the nanowires being aligned perpendicularly to the surface of the inorganic light emitting layer.

5. The electroluminescent device of claim 1, comprised of the nanorods comprising carbon nanotubes (CNTs) aligned perpendicular to the surface of the inorganic light emitting layer.

6. The electroluminescent device of claim 1, comprised of the inorganic light emitting layer being made from at least one of an electroluminescent (EL) phosphor material and a cathode luminescent (CL) phosphor material.

7. The electroluminescent device of claim 1, comprised of the first electrode being made from a transparent conductive material.

8. The electroluminescent device of claim 7, comprised of the transparent conductive material comprising ITO.

9. The electroluminescent device of claim 1, comprised of the second electrode being made from one of a transparent and electrically conductive material or from an electrically conducting metal.

10. The electroluminescent device of claim 1, comprised of the dielectric layer being made from SiO₂.

11. The electroluminescent device of claim 1, further comprising a dielectric layer formed on an inner surface of the first electrode.

12. The electroluminescent device of claim 1, comprised of an alternating polarity voltage being applied between the first and second electrodes.

13. An electroluminescent device comprising:
a first electrode and a second electrode spaced apart from each other and facing each other;
a field emission light emitting layer disposed between the first and second electrodes and made from a mixture of a field emission material comprised of nanorods and an inorganic light emitting material; and
a dielectric layer formed on an inner surface of the second electrode.

14. The electroluminescent device of claim 13, comprised of the nanorods comprising nanowires.

15. The electroluminescent device of claim 14, comprised of the nanowires being made from a material selected from the group of ZnO, TiO and SiC.

16. The electroluminescent device of claim 14, comprised of the nanowires being vertically aligned.

17. The electroluminescent device of claim 13, comprised of the nanorods comprising vertically aligned CNTs.

18. The electroluminescent device of claim 13, comprised of the inorganic light emitting layer comprising at least one of an electroluminescent (EL) phosphor material and a cathode luminescent (CL) phosphor material.

19. The electroluminescent device of claim 13, comprised of the first electrode being made from a transparent and electrically conductive material.

20. The electroluminescent device of claim 13, comprised of the second electrode being made from a transparent and electrically conductive material or an electrically conducting metal.

21. The electroluminescent device of claim 13, further comprising a dielectric layer formed on an inner surface of the first electrode.

22. The electroluminescent device of claim 13, comprised of an alternating polarity voltage being applied between the first and second electrodes.

23. The electroluminescent device of claim 13, wherein the amount of the field emission material with respect to the inorganic light emitting material is 0.01 through 10 wt %.
